(19) United States
(12) Patent Application Publication
(10) Pub. No.: US 2024/0245122 A1
(43) Pub. Date: Jul. 25, 2024

(54) FLAVOR INHALER AND FLAVOR INHALATION SYSTEM

(71) Applicant: Japan Tobacco Inc., Tokyo (JP)

(72) Inventors: Tetsuya YOSHIMURA, Tokyo (JP); Yasunobu INOUE, Tokyo (JP); Manabu YAMADA, Tokyo (JP)

(73) Assignee: Japan Tobacco Inc., Tokyo (JP)

(21) Appl. No.: 18/624,232

(22) Filed: Apr. 2, 2024

Related U.S. Application Data
(63) Continuation of application No. PCT/JP2021/042715, filed on Nov. 22, 2021.

(51) Int. Cl. A24F 40/46; A24F 40/20; H05B 3/22

(52) U.S. Cl. CPC A24F 40/46; A24F 40/20; H05B 3/22; H05B 2203/02

(57) ABSTRACT

Provided is a flavor inhaler. This flavor inhaler comprises a housing portion that has an opening and houses at least a portion of a consumable material via the opening, a heating portion that is inserted into the consumable material housed in the housing portion and heats the consumable material from the interior thereof, and a guide portion that forms the opening and causes the cross-sectional shape of the consumable material, when inserted into the housing portion, to deform so as to conform to the shape of the heating portion.

### CROSS-REFERENCE TO RELATED APPLICATION

This is a continuation of International Application No. PCT/JP2021/042715 filed on Nov. 22, 2021, the entire contents of which are incorporated herein by reference.

### TECHNICAL FIELD

The present invention relates to a flavor inhaler and a flavor inhalation system.

### BACKGROUND ART

A known flavor inhaler is used to inhale flavor or the like without burning a material. The flavor inhaler includes, for example, a chamber having a non-circular shape that compresses and holds a consumable material inserted into the chamber (see, for example, PTL 1).

### CITATION LIST

Patent Literature

PTL 1: United States patent Application Publication No. 2016/0360794

### SUMMARY OF INVENTION

### Technical Problem

A heater that heats the inside of a consumable material is useful for reducing the system size. When a chamber that compresses the consumable material as described in PTL 1 is used to increase the heating efficiency, the user inserts the heater into the consumable material while the consumable material is compressed. Therefore, the heater and the consumable material receive stress, and may be damaged. One object of the present invention is to provide a flavor inhaler and a flavor inhalation system that enable smooth insertion of the heater into the consumable material.

### solution to Problem

A first aspect of the present invention provides a flavor inhaler. This flavor inhaler includes: an accommodating unit having an opening and configured to accommodate at least a portion of a consumable material inserted through the opening; a heating unit configured to be inserted into the consumable material accommodated in the accommodating unit and heat the consumable material from inside; and a guide section defining the opening and configured to deform a cross-sectional shape of the consumable material inserted into the accommodating unit to a shape corresponding to a shape of the heating unit.

According to the first aspect of the present invention, the guide section deforms the cross-sectional shape of the consumable material inserted into the accommodating unit to a shape corresponding to the shape of the heating unit. Therefore, even when the cross-sectional shape of the consumable material inserted into the accommodating unit varies, the cross-sectional shape of the consumable material can be deformed into the desired shape corresponding to the shape of the heating unit by the guide section.

According to a second aspect of the present invention, in the first aspect, the guide section has a tapered shape that expands toward an outside of the accommodating unit.

According to the second aspect of the present invention, since the guide section has a tapered shape, the insertion of the consumable material is guided, and the consumable material can be easily accommodated in the accommodating unit.

According to a third aspect of the present invention, in the first or second aspect, the guide section has a minimum inner perimeter that is less than or equal to an outer perimeter of the consumable material.

According to the third aspect of the present invention, when the consumable material passes the guide section, the entire perimeter of the consumable material comes into contact with the guide section, so that the cross-sectional shape of the consumable material can be more reliably deformed into a shape that follows the shape of the guide section.

According to a fourth aspect of the present invention, in any one of the first to third aspects, the guide section includes an inlet portion provided at an end portion of the guide section adjacent to the opening and having an elliptical shape in cross section, the inlet portion having a major axis longer than or as long as a major axis of the consumable material after being accommodated in the accommodating unit.

According to the fourth aspect of the present invention, since the inlet portion has an elliptical shape in cross section, the cross-sectional shape of the consumable material can be easily deformed into an elliptical shape that follows the shape of the inlet portion.

According to a fifth aspect of the present invention, in any one of the first to fourth aspects, the guide section includes an inlet portion provided at an end portion of the guide section adjacent to the opening and having an elliptical shape in cross section, the inlet portion having a minor axis substantially as long as a diameter of the consumable material before being accommodated in the accommodating unit.

According to the fifth aspect of the present invention, since the minor axis of the inlet portion is substantially as long as the diameter of the consumable material before being accommodated in the accommodating unit, the consumable material can be restrained from wobbling in the direction of the minor axis of the inlet portion.

According to a sixth aspect of the present invention, in any one of the first to fifth aspects, an end portion of the heating unit adjacent to the opening protrudes toward the opening beyond an end portion of the guide section opposite to an end portion adjacent to the opening.

According to the sixth aspect of the present invention, since the end portion of the heating unit adjacent to the opening protrudes toward the opening beyond the end portion of the guide section opposite to the end portion adjacent to the opening, the heating unit can reliably start deforming the consumable material inserted through the opening.

According to a seventh aspect of the present invention, in any one of the first to sixth aspects, the heating unit is flat-plate-shaped, and the guide section includes an inlet portion provided at an end portion of the guide section adjacent to the opening and having an elliptical shape in cross section. A width direction of the heating unit coincides with a direction of a major axis of the inlet portion.

According to the seventh aspect of the present invention, since the width direction of the heating unit coincides with the direction of the major axis of the guide section having an elliptical shape in cross section, the consumable material inserted into the accommodating unit can be deformed into a shape that follows the shape of the heating unit. Therefore, the consumable material can be brought into close contact with the heating unit, and the efficiency of heat transmission from the heating unit to the consumable material can be increased.

According to an eighth aspect of the present invention, in the seventh aspect, the heating unit has a maximum width of greater than 30% of a length of the major axis of the consumable material after being accommodated in the accommodating unit.

According to the eighth aspect of the present invention, since the maximum width of the heating unit is greater than 30% of the length of the major axis of the consumable material after being accommodated in the accommodating unit, the consumable material inserted into the accommodating unit can be deformed into a flat shape, so that the consumable material can be brought into closer contact with the heating unit.

According to a ninth aspect of the present invention, in any one of the first to eighth aspects, an end portion of the heating unit adjacent to the opening has a sharp shape.

According to the ninth aspect of the present invention, since the end portion of the heating unit adjacent to the opening has a sharp shape, the heating unit can be easily inserted into the consumable material.

According to a tenth aspect of the present invention, in any one of the first to ninth aspects, the heating unit is a PTC heater.

According to the tenth aspect of the present invention, since the PTC heater is used, the consumable material can be efficiently heated without using a control device or the like.

An eleventh aspect of the present invention provides a flavor inhalation system. This flavor inhalation system includes a consumable material and the flavor inhaler according to any one of the first to tenth aspects.

According to the eleventh aspect of the present invention, a flavor inhalation system including a flavor inhaler can be provided. In the flavor inhaler, the guide section deforms the cross-sectional shape of the consumable material inserted into the accommodating unit to a shape corresponding to the shape of the heating unit. Therefore, even when the cross-sectional shape of the consumable material inserted into the accommodating unit varies, the cross-sectional shape of the consumable material can be deformed into the desired shape corresponding to the shape of the heating unit by the guide section.

According to a twelfth aspect of the present invention, in the eleventh aspect, the consumable material includes an insertion portion into which the heating unit configured to heat the consumable material from inside is inserted, and the insertion portion includes an annular sheet disposed to surround the heating unit inserted into the insertion portion.

According to the twelfth aspect of the present invention, since the insertion portion includes the annular sheet disposed to surround the heating unit inserted into the insertion portion, the shape of the consumable material can be easily deformed when the heating unit is inserted into the consumable material.

### BRIEF DESCRIPTION OF DRAWINGS

FIG. 1 is a sectional view of the main part of a flavor inhaler according to an embodiment of the present invention taken along a width direction of a heater.

FIG. 2 is a sectional view of the main part of the flavor inhaler according to the embodiment of the present invention taken along a thickness direction of the heater.

FIG. 3 is an exploded perspective view of the heater illustrated in FIG. 1.

FIG. 4 is a perspective view of the heater illustrated in FIG. 1.

FIG. 5 is a schematic side-sectional view of a consumable material according to an embodiment of the present invention.

FIG. 6 is a sectional view illustrating a tobacco portion in cross section orthogonal to a longitudinal direction of the consumable material illustrated in FIG. 5.

FIG. 7 shows sectional views of the consumable material accommodated in the flavor inhaler.

FIG. 8 shows sectional views of the consumable material accommodated in the flavor inhaler.

FIG. 9 shows sectional views of the consumable material accommodated in the flavor inhaler.

FIG. 10 shows other sectional views of the consumable material accommodated in the flavor inhaler.

FIG. 11 is a sectional view illustrating an arrangement of retaining ribs in the width direction of the heater.

FIG. 12 is a sectional view illustrating an arrangement of retaining ribs in the width direction of the heater.

FIG. 13 is a sectional view illustrating an arrangement of retaining ribs in the thickness direction of the heater.

### DESCRIPTION OF EMBODIMENTS

Embodiments of the present invention will now be described with reference to the drawings. In the drawings referred to below, the same or corresponding structural elements are denoted by the same reference signs, and redundant description thereof is omitted. In the following embodiments, a tobacco stick will be described as an example of a consumable material. However, the consumable material is not limited to tobacco as long as the consumable material generates flavor when heated.

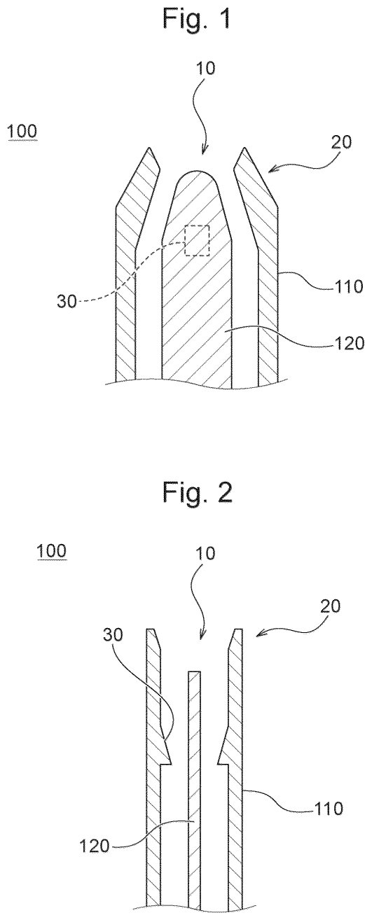

FIG. 1 is a sectional view of the main part of a flavor inhaler 100 according to an embodiment of the present invention taken along a width direction of a heater 120. FIG. 2 is a sectional view of the main part of the flavor inhaler 100 according to the embodiment of the present invention taken along a thickness direction of the heater 120.

As illustrated in FIGS. 1 and 2, the flavor inhaler 100 includes a housing (accommodating unit) 110 and a heater (heating unit) 120. The housing 110 has an opening 10 at one end, and receives at least a portion of a consumable material 200 (described below) inserted into the opening 10 through the opening 10. The housing 110 is made of, for example, a resin. In particular, the housing 110 may be made of polycarbonate (PC), acrylonitrile-butadiene-styrene (ABS) resin, polyetheretherketone (PEEK), a polymer alloy containing a plurality of types of polymers, or a metal, such as aluminum. The housing 110 is formed such that the cross-sectional area of the housing 110 in cross section orthogonal to the longitudinal direction thereof is smallest at a location near the opening 10.

The housing 110 includes a shaping guide (guide section) 20 and retaining ribs (urging section) 30. The shaping guide 20 defines the opening 10, and deforms the cross-sectional shape of the consumable material 200 inserted into the housing 110 to a shape corresponding to the shape of the heater 120. The retaining ribs 30 are provided on an inner peripheral surface of the housing 110 and urge the consumable material 200 inserted into the housing 110 toward the heater 120, thereby deforming the shape of the consumable material 200. The detailed structures of the shaping guide 20 and the retaining ribs 30 and the function of deforming the consumable material 200 will be described below.

The housing 110 has an air inlet (not illustrated) at an end opposite to the end at which the opening 10 is provided, that is, at the bottom of the housing 110. This air inlet allows air to be supplied to the consumable material 200 inserted in the housing 110. Thus, the flavor inhaler 100 is structured as a bottom-flow flavor inhaler. The air inlet may be formed in a member constituting the bottom of the housing 110 and communicate with the consumable material 200 through the inside of the member. When the air inlet is provided at the end of the housing 110 opposite to the end at which the opening 10 is provided, the structure of the housing 110 can be simplified in the region around the opening 10. In addition, convection in the air layer 40 (described below) can be suppressed, and the thermal insulation performance of the air layer 40 can be maintained.

The heater 120 is a flat-plate-shaped positive temperature coefficient (PTC) heater that is inserted into the consumable material 200 accommodated in the housing 110 and that heats the consumable material 200 from the inside. The heater 120 deforms the shape of the consumable material 200 inserted into the housing 110 to a shape that follows the shape of the heater 120. The function of deforming the consumable material 200 with the heater 120 will be described below. The shaping guide 20, the retaining ribs 30, and the heater 120 deform the shape of the consumable material 200 so that the shape of the consumable material 200 after being accommodated in the housing 110 differs from the shape of the consumable material 200 before being accommodated in the housing 110.

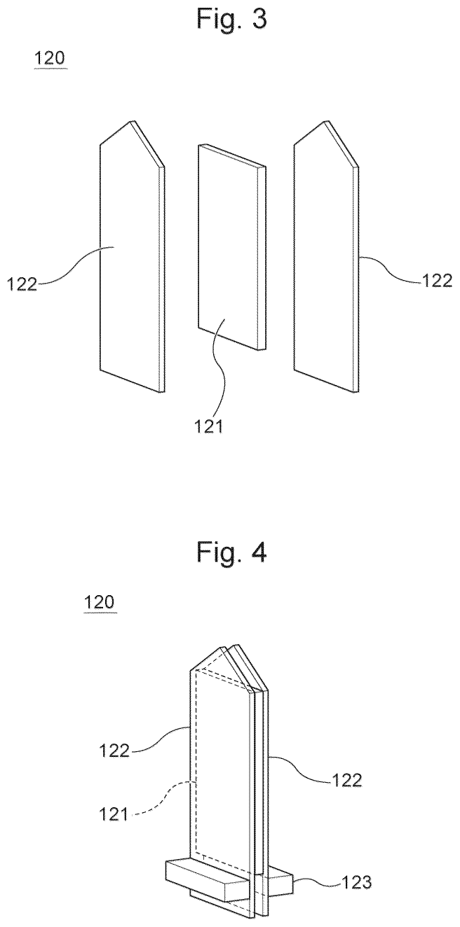

FIG. 3 is an exploded perspective view of the heater illustrated in FIG. 1. FIG. 4 is a perspective view of the heater illustrated in FIG. 1. As illustrated in FIGS. 3 and 4, the heater 120 includes a PTC element 121, at least two metal plates 122, and a holding member 123. The PTC element 121 is sandwiched between the metal plates 122 and bonded to the metal plates 122 by, for example, a conductive adhesive paste. The conductive adhesive paste may be, for example, an anisotropic conductive adhesive obtained by uniformly dispersing conductive particles in an epoxy-based adhesive.

The metal plates 122 may be made of an iron alloy containing nickel (Ni), such as Invar (registered trademark), having a low coefficient of thermal expansion. In such a case, separation of the metal plates 122 from the PTC element 121 due to thermal expansion caused when the PTC element 121 is heated can be suppressed. In addition, since the PTC element 121 is sandwiched between the at least two metal plates 122, the metal plates 122 can support the PTC element 121 and serve as electrodes at the same time.

The holding member 123 is joined to the housing 110 when the heater 120 is attached to the housing 110. The holding member 123 may be made of an engineering plastic. Engineering plastics have high heat resistance and mechanical strength, and can be formed into a desired shape at low cost by, for example, injection molding. Therefore, engineering plastics are suitable for use as the material of a structural member. For example, the holding member 123 may be formed of PEEK, which is an example of engineering plastic. PEEK is a thermoplastic resin having significantly high heat resistance and high dimensional stability. Therefore, when the holding member 123 is made of PEEK, the influence of heat generated by the heater 120 on the holding member 123 can be reduced.

The PTC heater is a heater including a resistor having characteristics (PTC characteristics) such that the electrical resistance suddenly increases and the current stops flowing when a certain temperature (referred to as the Curie temperature) is reached. By utilizing the PTC characteristics, the PTC heater is capable of maintaining the temperature at or below a predetermined temperature without using a control device or the like. The heater 120 may be a PTC heater including a resistor made of barium titanate (BaTiO₃) having the PTC characteristics. In this case, the Curie temperature of the barium titanate that forms the heater 120 can be set to 350° C., and therefore the consumable material 200 can be heated at a temperature of less than 350° C.

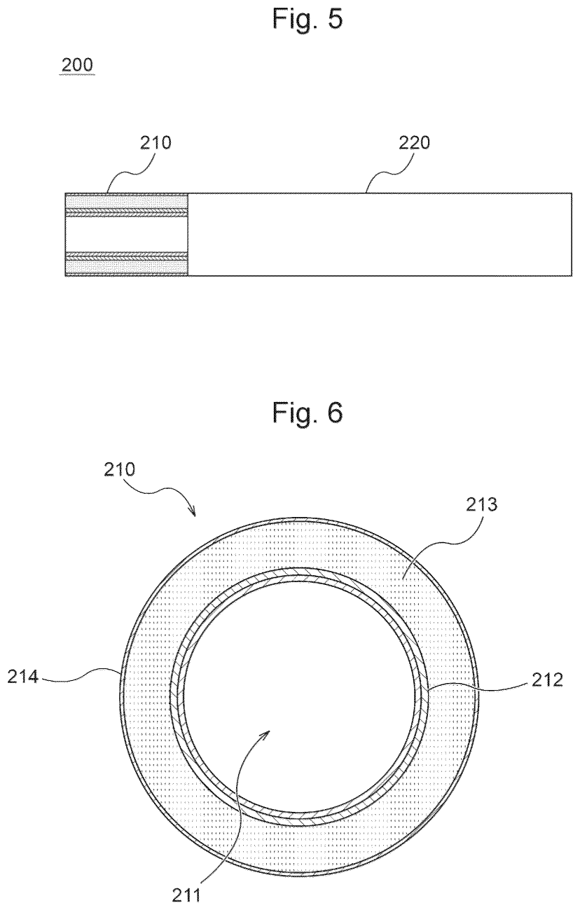

FIG. 5 is a schematic side sectional view of the consumable material 200 according to an embodiment of the present invention. FIG. 6 is a sectional view illustrating a tobacco portion 210 in cross section orthogonal to the longitudinal direction of the consumable material 200 illustrated in FIG. 5. As illustrated in FIGS. 5 and 6, the consumable material 200 includes the tobacco portion (insertion portion) 210 and a paper tube 220. The tobacco portion 210 has a through hole 211 in which the heater 120 is to be inserted at the center thereof. The tobacco portion 210 includes a flavor-releasing layer (annular sheet) 212, which has a two-layer structure and is disposed to surround the inserted heater 120, and an elastic deformation layer (annular sheet) 213. The outer periphery of the elastic deformation layer 213 is wrapped with a wrapper 214.

The flavor-releasing layer 212 includes, for example, a tobacco sheet and a non-tobacco sheet disposed on the outer periphery of the tobacco sheet and carrying glycerine. The flavor-releasing layer 212 releases a volatile compound containing flavor when heated by the heater 120. The flavor-releasing layer 212 may include only one of the tobacco sheet and the non-tobacco sheet. The elastic deformation layer 213 may be composed of, for example, a nonwoven fabric sheet, a corrugated sheet, or a non-tobacco sheet, and is elastically deformable in the thickness direction (that is, in the radial direction of the cylindrical elastic deformation layer 213). Upon insertion of the heater 120, the elastic deformation layer 213 contributes to the deformation of the consumable material 200 into a shape that follows the shape of the heater 120.

Thus, when the heater 120 is inserted into the through hole 211, the elastic deformation layer 213 is elastically deformed in the thickness direction relative to the heater 120 and easily approaches or comes into contact with the heater 120. Therefore, the flavor-releasing layer 212 can further approach or come into contact with the heater 120, so that the consumable material 200 can be efficiently heated.

The paper tube 220 cools the volatile compound released from the flavor-releasing layer 212. Since the tobacco portion 210 includes the flavor-releasing layer 212 and the elastic deformation layer 213 disposed to surround the inserted heater 120, the shape of the consumable material 200 can be easily deformed when the heater 120 is inserted into the consumable material 200. The consumable material 200 may have a circular or elliptical shape in cross section.

The non-tobacco sheet may contain a flavor-generating base material. The flavor-generating base material is a material that generates smoke scent and taste, and is preferably a tobacco material. The flavor-generating base material may include a flavoring agent. The flavoring agent is a substance that provides scent and taste. The flavoring agent may be a natural flavoring agent or a synthetic flavoring agent. The flavoring agent may be a single type of flavoring agent or a mixture of multiple types of flavoring agents. The flavoring agent may be any commonly used flavoring agent, such as essential oil, a natural flavoring agent, or a synthetic flavoring agent. The flavoring agent may be liquid or solid, and may have any properties. The flavor-generating base material may include a refreshing agent or a seasoning.

The tobacco sheet may contain, for example, tobacco and a polyhydric alcohol. The polyhydric alcohol contained in the tobacco sheet may be a single type of polyhydric alcohol or a combination of two or more types of polyhydric alcohol. The polyhydric alcohol may also be added to the above-described elastic deformation layer 213. The tobacco sheet is formed in a sheet shape by mixing a binder with powdered tobacco and the polyhydric alcohol.

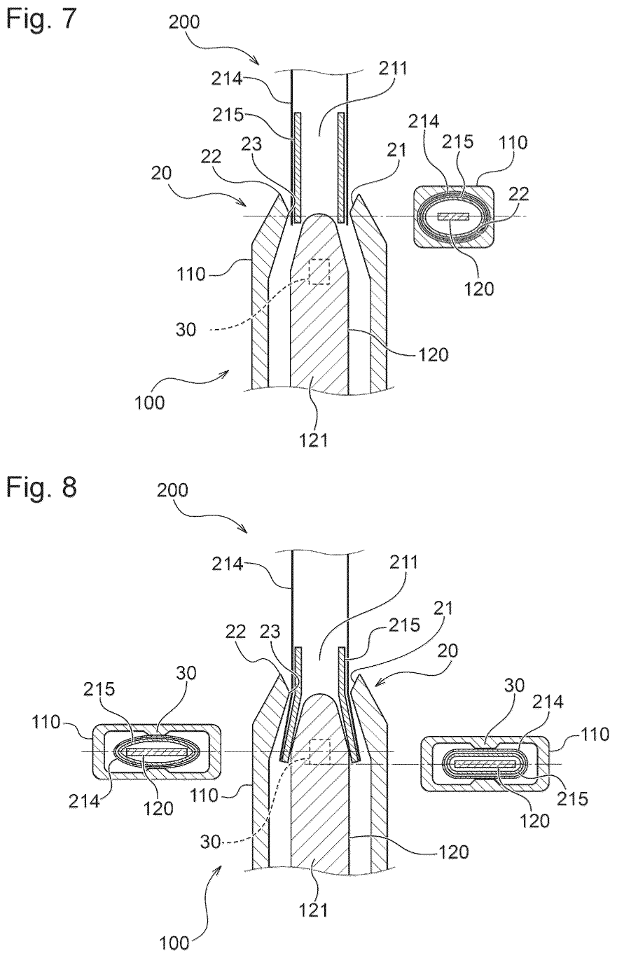

The relationship between the consumable material 200, the housing 110, and the heater 120 when the consumable material 200 is accommodated in the flavor inhaler 100, that is, when the consumable material 200 is inserted from one end of the housing 110 toward the other end, will now be described. FIGS. 7 to 9 are sectional views illustrating the consumable material 200 accommodated in the flavor inhaler 100. A flavor inhalation system is formed by applying the consumable material 200 to the flavor inhaler 100. In FIGS. 7 to 9, the flavor-releasing layer 212 and the elastic deformation layer 213 of the consumable material 200 are shown as a single annular sheet 215.

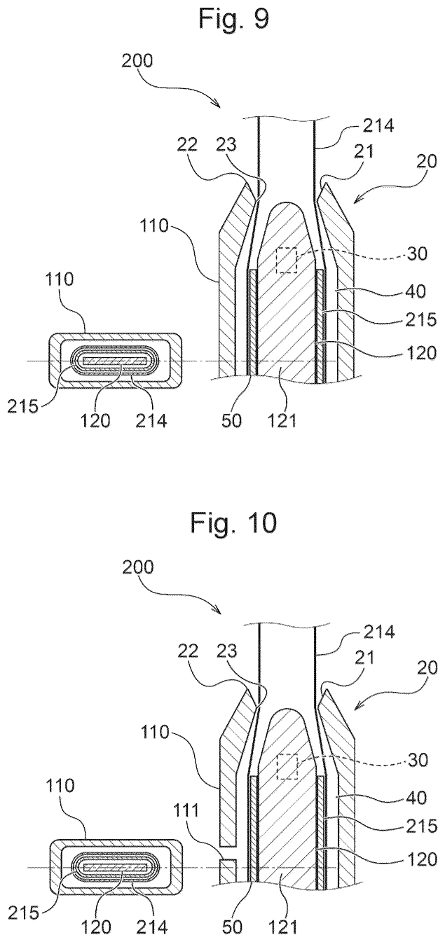

FIG. 7 illustrates the consumable material 200 passing the shaping guide 20 in a cross section taken along the width direction of the heater 120 and a cross section orthogonal to the longitudinal direction of the housing 110 at an inlet portion 22 of the shaping guide 20. FIG. 8 illustrates the consumable material 200 passing the retaining ribs 30 in a cross section taken along the width direction of the heater 120 and cross sections orthogonal to the longitudinal direction of the housing 110 at intermediate portions of the retaining ribs 30 and end portions of the retaining ribs 30 adjacent to the other end. FIG. 9 illustrates the consumable material 200 accommodated at a predetermined accommodation position in the housing 110 in a cross section taken along the width direction of the heater 120 and a cross section orthogonal to the longitudinal direction of the housing 110 at a position close to an end portion of the heater 120 adjacent to the other end.

As illustrated in FIG. 7, the shaping guide 20 includes a tapered portion 21, the inlet portion 22, and a contact portion 23. The tapered portion 21 is formed to expand toward the one end of the housing 110, and guides the insertion of the consumable material 200 into the flavor inhaler 100. In other words, the shaping guide 20 guides the consumable material 200 to a tip of the heater 120 so that the consumable material 200 can be reliably inserted into the heater 120. More specifically, since the shaping guide 20 has a tapered shape that expands toward the outside of the housing 110, the insertion of the consumable material 200 is guided so that the consumable material 200 can be easily accommodated in the housing 110.

The inlet portion 22 is provided at an end portion of the housing 110 and has an elliptical shape in cross section. The inlet portion 22 has a major axis longer than or as long as the major axis of the consumable material 200 after being accommodated in the housing 110, and a minor axis substantially as long as the diameter of the consumable material 200 before being accommodated in the housing 110. Since the shaping guide 20 has an elliptical shape in cross section at the end thereof, the cross-sectional shape of the consumable material 200 can be deformed into an elliptical shape that follows the shape of the shaping guide 20 during the insertion of the consumable material 200. In addition, since the minor axis of the inlet portion 22 is substantially as long as the diameter of the consumable material 200 before being accommodated in the housing 110, the consumable material 200 can be restrained from wobbling in the direction of the minor axis of the shaping guide 20. Even when the dimensions of the end surface of consumable material 200 vary, the consumable material 200 can be shaped into a constant shape by the shaping guide 20, and can be smoothly attached to the housing 110.

The heater 120 and the inlet portion 22 are arranged such that the width direction of the heater 120 coincides with the direction of the major axis of the inlet portion 22. This allows the consumable material 200 inserted into the housing 110 to be deformed into a shape that follows the shape of the heater 120. Therefore, the consumable material 200 can be brought into close contact with the heater 120, and the efficiency of heat transmission from the heater 120 to the consumable material 200 can be increased.

The contact portion 23 is provided on the inner peripheral surface of the housing 110 and has an elliptical shape in cross section. The contact portion 23 has a minimum inner perimeter that is less than or equal to the outer perimeter of the consumable material 200. Accordingly, when the consumable material 200 passes the shaping guide 20, the entire perimeter of the consumable material 200 comes into contact with the contact portion 23, so that the cross-sectional shape of the consumable material 200 can be more reliably deformed into a shape that follows the shape of the contact portion 23. Therefore, even when the cross-sectional shape of the consumable material 200 varies, the consumable material 200 can be deformed to have a desired cross-sectional shape by the shaping guide 20, and smoothly inserted into the housing 110. In addition, since the entire perimeter of the consumable material 200 comes into contact with the contact portion 23, the consumable material 200 can be prevented from falling.

The contact portion 23 is formed such that the contact portion 23 comes into point-contact with the consumable material 200 accommodated in the housing 110 in cross section taken along the longitudinal axis of the housing 110. When the contact portion 23 is in point-contact with the consumable material 200, heat transmission from the consumable material 200 to the housing 110 is reduced. Accordingly, the thermal insulation performance of the flavor inhaler 100 is increased.

The heater 120 has a sharp shape with a pointed tip. Therefore, the heater 120 can be easily inserted into the consumable material 200. An end portion of the heater 120 adjacent to the opening 10 protrudes toward the opening 10 beyond an end portion of the shaping guide 20 opposite to an end portion adjacent to the opening 10. More specifically, the end portion of the heater 120 adjacent to the opening 10 slightly protrudes from the contact portion 23 toward the one end of the housing 110 in the longitudinal direction of the housing 110. Therefore, the end portion of the heater 120 adjacent to the opening 10 is inserted into the through hole 211 in the consumable material 200 at the time when the consumable material 200 passes the shaping guide 20, and therefore the heater 120 can reliably start deforming the consumable material 200.

A maximum width of the heater 120 relative to the length of the major axis of the contact portion 23 of the shaping guide 20 is greater than that in a flavor inhaler including a heater of an insertion type according to the related art. For example, the major axis of the contact portion 23 is 7 mm long, and the maximum width of the heater 120 is 6 mm. The heater 120 has a maximum width of greater than 30%, preferably greater than 40%, of the length of the major axis of the consumable material 200 after being accommodated in the housing 110. Thus, the consumable material 200 inserted into the housing 110 can be deformed into a flat shape and brought into closer contact with the heater 120.

As illustrated in FIG. 8, the heater 120 has a sharp shape, and the width thereof increases toward the other end. Accordingly, as the consumable material 200 is inserted beyond the shaping guide 20, the shape of the consumable material 200 is deformed into a shape that follows the shape of the heater 120. More specifically, the consumable material 200 is expanded in the width direction of the heater 120. Thus, the consumable material 200 can be brought into close contact with the heater 120, and the efficiency of heat transmission from the heater 120 to the consumable material 200 can be increased. In addition, since the consumable material 200 is expanded by the heater 120, the consumable material 200 can be prevented from falling.

More specifically, the heater 120 is flat-plate-shaped, and deforms the outer shape of the consumable material 200 inserted into the housing 110 to an elliptical shape in cross section. At this time, the major axis of the consumable material 200 after being accommodated in the housing 110 is longer than the diameter of the consumable material 200 before being accommodated in the housing 110, and the minor axis of the consumable material 200 after being accommodated in the housing 110 is shorter than the diameter of the consumable material 200 before being accommodated in the housing 110. Since the heater 120 deforms the outer shape of the consumable material 200 inserted into the housing 110 to an elliptical shape in cross section, the space occupied by the consumable material 200 in the housing 110 can have a reduced dimension in the transverse direction. Therefore, the thickness of the housing 110 can be reduced. In addition, since the heater 120 deforms the outer shape of the consumable material 200 inserted into the housing 110 to an elliptical shape in cross section, the contact area between the heater 120 and the consumable material 200 can be increased. Therefore, the efficiency of heat transmission from the heater 120 to the consumable material 200 can be increased.

The perimeter of the heater 120 in cross section orthogonal to the longitudinal direction of the housing 110 gradually increases from the end adjacent to the opening 10 toward the end opposite to the end adjacent to the opening 10, that is, from one end toward the other end. Since the perimeter of the heater 120 gradually increases from one end toward the other end, the contact length between the consumable material and the heating unit gradually increases from one end toward the other end, and therefore the consumable material can be prevented from falling.

The retaining ribs 30 are provided to protrude from the inner peripheral surface of the housing 110 toward the heater 120 in the thickness direction of the heater 120, and include a pair of tapered surfaces facing each other (see FIG. 2). The retaining ribs 30 are not limited to this as long as at least one retaining rib 30 is provided at each of positions facing each other. The retaining ribs 30 are disposed to overlap a region in which the width of the heater 120 gradually increases in the longitudinal direction of the housing 110. Any protruding shape may be selected as the shape of the retaining ribs 30.

The retaining ribs 30 may be formed to protrude by a distance that gradually increases toward the other end of the housing 110 and by a maximum distance at the position at which the heater 120 has a maximum width, that is, at which the heater 120 has a maximum perimeter in cross section orthogonal to the longitudinal direction of the housing 110. In this case, the distance between the tapered surfaces of the retaining ribs 30 is less than the diameter of the consumable material 200 before being inserted into the housing 110. Each retaining rib 30 has a stopper-shaped end portion with an end surface substantially orthogonal to the inner peripheral surface of the housing 110 at the other end, and is disposed so as not to overlap with the PTC element 121 of the heater 120 in the longitudinal direction of the housing 110.

Accordingly, when the consumable material 200 passes the retaining ribs 30, the consumable material 200 expanded in the width direction of the heater 120 is urged by the retaining ribs 30 in the thickness direction of the heater 120, so that the consumable material 200 is deformed into a flat shape. In intermediate regions of the retaining ribs 30, the distance by which the retaining ribs 30 protrude increases as the width of the heater 120 increases, so that the consumable material 200 is gradually deformed into the flat shape.

In contrast, the width of the heater 120 and the distance by which the retaining ribs 30 protrude are both at a maximum at the end portions of the retaining ribs 30 at the other end, and the consumable material 200 is in a final shape in which the consumable material 200 is in close contact with the heater 120. Thus, the consumable material 200 inserted into the housing 110 is urged toward the heater 120 by the retaining ribs 30, so that the consumable material 200 can be brought into closer contact with the heater 120 and that the efficiency of heat transmission from the heater 120 to the consumable material 200 can be further increased. In addition, since the consumable material 200 is urged by the retaining ribs 30, the consumable material 200 can be prevented from falling.

The consumable material 200 illustrated in FIGS. 5 and 6 may be formed such that the distance from an inner periphery to an outer periphery of the tobacco portion 210 in a radial direction in cross section orthogonal to the longitudinal direction of the consumable material 200 is greater than the minimum distance between the heater 120 and each retaining rib 30. In such a case, the consumable material 200 can be reliably urged against the heater 120 by the retaining ribs 30, and the efficiency of heat transmission from the heater 120 to the consumable material 200 can be further increased.

When the retaining ribs 30 are arranged in the thickness direction of the heater 120 as described above, the consumable material 200 inserted into the housing 110 can be deformed into a flat shape to bring the consumable material 200 into closer contact with the heater 120. Since at least one retaining rib 30 is provided at each of positions facing each other, the consumable material 200 inserted into the housing 110 can be urged toward the heater 120 in the opposite directions. When the distance between the tapered surfaces of the retaining ribs 30 is less than the diameter of the consumable material 200, the consumable material 200 can be brought into closer contact with the heater 120, and the efficiency of heat transmission from the heater 120 to the consumable material 200 can be further increased.

In addition, when the retaining ribs 30 are formed to protrude by a distance that gradually increases toward the other end of the housing 110, the consumable material 200 can be gradually deformed, and therefore can be smoothly deformed. In addition, when the end portions of the retaining ribs 30 at the other end are stopper-shaped, even if the consumable material 200 receives a force in a pull-out direction, the consumable material 200 can be prevented from falling because the stopper-shaped end portions generate resistance. In addition, when the retaining ribs 30 are disposed so as not to overlap with the PTC element 121 of the heater 120 in the longitudinal direction of the housing 110, the transmission of heat generated by the PTC element 121 to the housing 110 through the retaining ribs 30 can be suppressed.

As illustrated in FIG. 9, when the consumable material 200 is at the predetermined accommodation position in the housing 110, the consumable material 200 is maintained in the final shape illustrated in FIG. 8. In this state, an accommodation space 50 accommodating the consumable material 200 deformed by the heater 120 is formed in the housing 110. In addition, an air layer 40 is formed along the entire perimeter of the consumable material 200 between the accommodation space 50 and the housing 110. The air layer 40 has a low thermal conductivity, and is therefore capable of providing thermal insulation between the consumable material 200 (accommodation space 50) and the housing 110, thereby reducing the energy required to heat the consumable material 200. The contact portion 23 is in contact with the consumable material 200 over the entire perimeter of the outer periphery of the consumable material 200, and seals the air layer 40. Thus, the convection of air in the air layer 40 is suppressed.

The housing 110 is formed such that the cross-sectional area thereof in cross section orthogonal to the longitudinal direction of the housing 110 is smallest at a location close to the opening 10. Accordingly, the occurrence of convection in the air layer 40 due to the inward and outward airflows around the opening 10 can be suppressed, and the thermal insulation performance of the flavor inhaler 100 can be further increased. In addition, the housing 110 is formed such that the ratio of the cross-sectional area of the air layer 40 to the cross-sectional area of the consumable material 200 is in the range of 5:1 to 1:1 at a location at which the housing 110 has a maximum cross-sectional area in cross section orthogonal to the longitudinal direction of the housing 110. Thus, the air layer 40 has sufficient thermal insulation performance.

As described above, the shaping guide 20 deforms the cross-sectional shape of the consumable material 200, the heater 120 deforms the shape of the consumable material 200 into a shape that follows the shape of the heater 120, and the retaining ribs 30 urge the consumable material 200 toward the heater 120. Thus, the consumable material 200 inserted into the housing 110 can be deformed into a flat shape and brought into close contact with the heater 120. Therefore, the efficiency of heat transmission from the heater 120 to the consumable material 200 can be increased.

According to the flavor inhaler 100 having the above-described structure, the shaping guide 20 deforms the cross-sectional shape of the consumable material 200 inserted into the housing 110 to a shape corresponding to the shape of the heater 120. Therefore, even when the cross-sectional shape of the consumable material 200 inserted into the housing 110 varies, the cross-sectional shape of the consumable material 200 can be deformed into the desired shape corresponding to the shape of the heater 120 by the shaping guide 20.

In addition, according to the flavor inhaler 100 having the above-described structure, the heater 120 deforms the outer shape of the consumable material 200 inserted into the housing 110 to a shape that follows the shape of the heater 120. Therefore, the consumable material 200 can be brought into close contact with the heater 120, and the efficiency of heat transmission from the heater 120 to the consumable material 200 can be increased.

Even when the shaping guide 20, the retaining ribs 30, and the heater 120 deform the consumable material 200 such that the shape of the consumable material 200 after being accommodated in the housing 110 differs from the shape of the consumable material 200 before being accommodated in the housing 110, the air layer 40 is formed between the accommodation space 50 accommodating the deformed consumable material 200 and the housing 110. Therefore, the air layer 40, which has a low thermal conductivity, serves to improve the thermal insulation performance of the flavor inhaler 100.

When the consumable material 200 is accommodated in the housing 110, the contact portion 23 seals the air layer 40 formed between the accommodation space 50 accommodating the deformed consumable material 200 and the housing 110, so that the convection of air in the air layer 40 can be suppressed and good thermal insulation can be achieved. In addition, since the contact portion 23 is close to the opening 10, the volume of the sealed air layer 40 can be increased, thereby improving the thermal insulation performance of the flavor inhaler 100.

Since the heater 120 is inserted into the consumable material 200 and heats the consumable material 200 from the inside, the heater 120, which is the heat source, does not come into contact with the air layer 40. Therefore, the thermal insulation performance of the flavor inhaler 100 can be further increased. In addition, since the air layer 40 is formed over the entire perimeter of the outer periphery of the consumable material 200, the thermal insulation performance of the flavor inhaler 100 can be still further increased.

Although the heater 120 is a PTC heater in the above-described embodiment, the heater is not limited to this. For example, the heater may be a flexible polyimide heater in which a heating resistor (heating element) made of, for example, stainless steel is sandwiched between two films (base members) made of, for example, polyimide (PI). Alternatively, the heater may be a pin heater having an elliptical shape in cross section orthogonal to the longitudinal direction of the housing 110. When the pin heater is used, the consumable material 200 inserted into the housing 110 occupies a space in the housing 110 with a smaller dimension in the transverse direction compared to when a pin heater of the same cross-sectional area with a circular cross section is used. Therefore, the thickness of the housing 110 can be reduced. In addition, when the retaining ribs 30 are arranged along the minor axis of the pin heater, the consumable material 200 inserted into the housing 110 can be deformed into a flat shape and brought into closer contact with the heater.

In the above-described embodiment, the housing 110 has an air inlet at an end opposite to the end at which the opening 10 is provided, that is, at the bottom of the housing 110. However, the air inlet is not limited to this, and an air inlet that directly communicates with the air layer 40 may be provided at the opening 10 of the housing 110 or in the housing 110. When the air inlet is provided in the housing 110, as illustrated in FIG. 10, an air inlet 111 may be formed near an end portion of the housing 110 at the other end. Also in this case, the air layer 40 is sealed by the contact portion 23, so that the occurrence of convection can be suppressed in the air layer 40 around the contact portion 23, and air can be introduced without causing a reduction in the heat insulation efficiency or changing the size of the flavor inhaler 100.

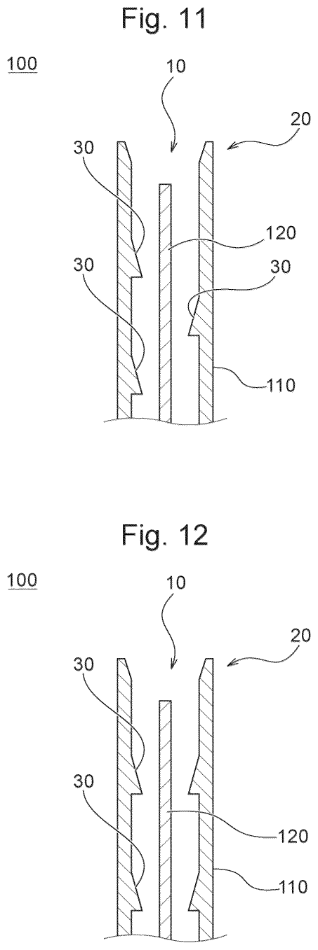

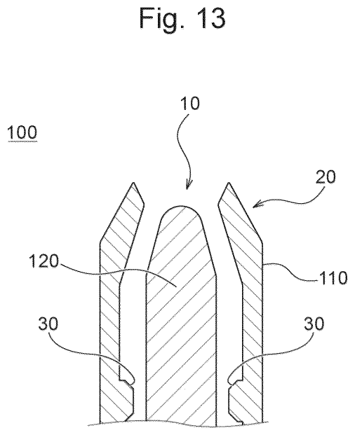

Although the retaining ribs 30 include a pair of tapered surfaces that face each other in the above-described embodiment, the retaining ribs 30 are not limited to this. FIGS. 11 and 12 are sectional views illustrating arrangements of the retaining ribs 30 in the width direction of the heater 120. FIG. 13 is a sectional view illustrating an arrangement of the retaining ribs 30 in the thickness direction of the heater 120.

In FIG. 11, the retaining ribs 30 are arranged in a staggered pattern along the longitudinal direction of the housing 110. When the retaining ribs 30 are arranged in this manner, frictional force is more gently applied to the consumable material 200 upon insertion of the consumable material 200 than when the retaining ribs 30 are disposed to face each other.

In FIG. 12, the retaining ribs 30 are disposed not only at the positions illustrated in FIG. 2 but also at positions near the end portion of the heater 120 at the other end so as to face each other in the thickness direction of the heater 120. In FIG. 13, the retaining ribs 30 are arranged at positions near the end portion of the heater 120 at the other end so as to face each other in the width direction of the heater 120. When the retaining ribs 30 are disposed near the end portion of the heater 120 at the other end as described above, the consumable material 200 can be reliably brought into close contact with the heater 120 to the tip of the consumable material 200, and the efficiency of heat transmission from the heater 120 to the consumable material 200 can be increased.

Although embodiments of the present invention have been described above, the above-described embodiments of the invention are intended to facilitate understanding of the present invention, and not to limit the present invention. The present invention can be modified or improved without departing from the spirit thereof, and includes equivalents thereto. Further, the structural elements described in the claims and the specification can be combined or omitted within a scope in which at least one of the above-described problems can be solved or a scope in which at least one of the above-described advantages can be obtained.

### REFERENCE SIGNS LIST

10 opening
20 shaping guide
21 tapered portion
22 inlet portion
23 contact portion
30 retaining rib
40 air layer
50 accommodation space
100 flavor inhaler
110 housing
111 air inlet
120 heater
121 PTC element
122 metal plate
123 holding member
200 consumable material
210 tobacco portion
211 through hole
212 flavor-releasing layer
213 elastic deformation layer
214 wrapper
215 annular sheet
220 paper tube

1. A flavor inhaler comprising:
an accommodating unit having an opening and configured to accommodate at least a portion of a consumable material inserted through the opening;
a heating unit configured to be inserted into the consumable material accommodated in the accommodating unit and heat the consumable material from inside; and
a guide section defining the opening and configured to deform a cross-sectional shape of the consumable material inserted into the accommodating unit to a shape corresponding to a shape of the heating unit.

2. The flavor inhaler according to claim 1,
wherein the guide section has a tapered shape that expands toward an outside of the accommodating unit.

3. The flavor inhaler according to claim 1,
wherein the guide section has a minimum inner perimeter that is less than or equal to an outer perimeter of the consumable material.

4. The flavor inhaler according to claim 1,
wherein the guide section includes an inlet portion provided at an end portion of the guide section adjacent to the opening and having an elliptical shape in cross section, the inlet portion having a major axis longer than or as long as a major axis of the consumable material after being accommodated in the accommodating unit.

5. The flavor inhaler according to claim 1,
wherein the guide section includes an inlet portion provided at an end portion of the guide section adjacent to the opening and having an elliptical shape in cross section, the inlet portion having a minor axis substantially as long as a diameter of the consumable material before being accommodated in the accommodating unit.

6. The flavor inhaler according to claim 1,
wherein an end portion of the heating unit adjacent to the opening protrudes toward the opening beyond an end portion of the guide section opposite to an end portion adjacent to the opening.

7. The flavor inhaler according to claim 1,
wherein the heating unit is flat-plate-shaped,
wherein the guide section includes an inlet portion provided at an end portion of the guide section adjacent to the opening and having an elliptical shape in cross section, and wherein a width direction of the heating unit coincides with a direction of a major axis of the inlet portion.

8. The flavor inhaler according to claim 7,
wherein the heating unit has a maximum width of greater than 30% of a length of the major axis of the consumable material after being accommodated in the accommodating unit.

9. The flavor inhaler according to claim 1,
wherein an end portion of the heating unit adjacent to the opening has a sharp shape.

10. The flavor inhaler according to claim 1,
wherein the heating unit is a PTC heater.

11. A flavor inhalation system comprising:
a consumable material; and
the flavor inhaler according to claim 1.

12. The flavor inhalation system according to claim 11,
wherein the consumable material includes an insertion portion into which the heating unit configured to heat the consumable material from inside is inserted, and
wherein the insertion portion includes an annular sheet disposed to surround the heating unit inserted into the insertion portion.
